(19) United States
(12) Patent Application Publication
(10) Pub. No.: US 2010/0250111 A1
(43) Pub. Date: Sep. 30, 2010

(54) EMERGENCY AND TRAFFIC ALERT SYSTEM

(75) Inventors: Juan Gutierrez, Lakewood, CO (US); Carl Johnson, Denver, CO (US)

Correspondence Address: MERCHANT & GOULD PC, P.O. BOX 2903, MINNEAPOLIS, MN, 55402-0903, US

(73) Assignee: B&C Electronic Engineering, Inc., Denver, CO (US)

(21) Appl. No.: 12/706,355

(22) Filed: Feb. 16, 2010

Related U.S. Application Data
(60) Provisional application No. 61/163,588, filed on Mar. 26, 2009.

(51) Int. Cl. G08G 1/0967; G01C 21/36; G06F 15/16

(52) U.S. Cl. 701/200; 709/203

(57) ABSTRACT

Systems and methods are disclosed for providing event notification to navigational applications. More specifically, the disclosed systems and methods provide emergency and non-emergency event information to users such that the event information is displayed to the user of a navigation application. For example, the location of an emergency event, such as a car accident or a fire is displayed on a personal navigation device. Furthermore, the real-time location of emergency vehicles responding to the event can be displayed on the navigation application. This provides additional information to drivers to help avoid traffic situations and clear the route for emergency vehicles. The disclosed systems and methods may also be employed to provide non-emergency information to users, such as parade or marathon information and routes, snow routes, evacuation routes, and traffic signal outages.

### CROSS-REFERENCE TO RELATED CASES

This utility patent application claims the benefit of previously filed U.S. Provisional Application No. 61/163,588 filed on Mar. 26, 2009, entitled “EMERGENCY VEHICLE NOTIFICATION SYSTEM”, which is hereby incorporated by reference.

### BACKGROUND

Navigation applications allow a user to map routes. Furthermore, the incorporation of GPS units and navigation applications provide users to get turn by turn directions from such application when operating a moving vehicle. Furthermore, navigation applications have evolved to provide rudimentary traffic information to users. However, current navigation applications fail to offer more information than a general sense of the traffic conditions, such as emergency event notifications. It is with respect to these and other considerations that embodiments of the systems and methods described herein have been made. Also, although relatively specific problems have been discussed, it should be understood that systems and methods described herein should not be limited to solving the specific problems identified in the background.

### SUMMARY

Embodiments of this disclosure describe technology for the driving public, including the hearing impaired, that will enable them to safely drive and receive timely information that will keep them far safer than in the past. Additionally, emergency responders will enhance their ability to move efficiently through traffic.

Further embodiments of the present disclosure expand upon the framework of the disclosed emergency vehicle notification systems and methods to provide other useful information to drivers to help them in avoiding traffic and/or traffic related accidents or incidents. For example, embodiments of the present disclosure can further provide information to drivers regarding scheduled incidents such as, but not limited to, races, road maintenance, marathons, parades, fairs, and/or neighborhood events as well as unscheduled events such as segments of traffic signal failure, water or sewer main breaks, flooded streets, downed wires, street repairs, construction, work by public utility companies, work by private contractors, etc. Although specific examples of scheduled and unscheduled incidents have been provided, one of skill in the art will recognize that such examples are provided as illustrative uses of embodiments of the present disclosure and that other scheduled and unscheduled incidents, not explicitly detailed in the present disclosure, are contemplated within the scope of this disclosure. Still, further embodiments contemplated within the present disclosure provide useful information to drivers in case of emergencies.

This summary is provided to introduce a selection of concepts in a simplified form that are further described below in the Detailed Description. This summary is not intended to identify key or essential features of the claimed subject matter, nor is it intended to be used to limit the scope of the claimed subject matter.

### BRIEF DESCRIPTION OF THE DRAWINGS

Embodiments of the present disclosure may be more readily described by reference to the accompanying drawings in which like numbers refer to like items and in which:

FIG. 1 is an illustration of an embodiment of a system operable to provide event notifications.

FIG. 2 is an illustration of an alternate embodiment of a system operable to provide event notifications.

FIG. 3 is a flow chart representing an embodiment of a method for providing emergency event information.

FIG. 4 is a flow chart illustrating an embodiment of a method for determining whether there is a change in the severity level during an active emergency event.

FIG. 5 is a flow chart representing an embodiment of a method for providing non-emergency event information.

FIG. 6 is a functional diagram illustrating a computer environment and computer system operable to execute embodiments of the present disclosure.

### DETAILED DESCRIPTION

This disclosure more fully describes exemplary embodiments with reference to the accompanying drawings, in which some of the possible embodiments are shown. Other aspects, however, may be embodied in many different forms and the inclusion of specific embodiments in the disclosure should not be construed as limiting such aspects to the embodiments set forth herein. Rather, the embodiments depicted in the drawings are included to provide a disclosure that is thorough and complete and which fully conveys the intended scope to those skilled in the art. When referring to the figures, like structures and elements shown throughout are indicated with like reference numerals.

With the amount of travel demanded on most of us on a daily basis, regardless if it is for work or pleasure, we are finding ourselves driving more miles every year than ever before. Every time we get in our vehicles we increase our exposure to the elements and dangers of any traffic commute. These elements have been concentrated on our exposure to our own driving habits as well as the unknown driving habits of other drivers. Some of the potential causes of auto accidents that we concentrate on are the obvious, such as, traffic volume, weather conditions, time of day or night, level of alertness, etc.

One aspect that is now getting its due recognition is how well our vehicles are now being built related to its insulation factor. Vehicles are more insulated to keep us warmer in the winter and cooler in the summer, as well as eliminating engine, tire and road noise from inside the vehicles. Add to the insulation factor normal internal noise from heating and air conditioning fans, radio, CD, MP3 players, and cell phone conversations, and we find ourselves totally insulated from all the exterior noises, some of which may be vital for us to drive in a safe manner.

One such factor that we may be unwillingly removing from our attention span is that of emergency vehicles (police, fire, and ambulances) approaching the driving public from any direction. Whenever any of these emergency vehicles approach us from the front, we depend on line of sight to identify their direction of travel and anticipate their travel route. However, oftentimes we may only hear an emergency vehicle that is already close behind us in the rear view mirror. Maybe even more dangerous is an intersection where we encounter an emergency vehicle at an angle and never hear their warning siren. This is particularly more evident during the day when flashing lights are not as visible as they are at night.

One other group of drivers that we as a society have not taken into consideration when addressing our driving public is the deaf and hearing impaired drivers. This is a group of approximately fifteen percent (15%) of the general population, and they are as active drivers as the other eighty-five percent (85%).

Embodiments of this disclosure describe technology for the driving public, including the hearing impaired, that will enable them to safely drive and receive timely information that will keep them far safer than in the past. Additionally, emergency responders will enhance their ability to move efficiently through traffic.

Every year innocent citizens are killed and/or seriously injured by responding emergency vehicles and police chases. Police agencies are faced with the dilemma of letting dangerous criminals get away from them, or risk a chase. It is during these types of events that the emergency vehicle notification system will help warn the driving public far out in front of a chase that they need to be extra cautious, and should pull over and stop at all intersections.

Further embodiments of the present disclosure expand upon the framework of the disclosed emergency vehicle notification systems and methods to provide other useful information to drivers in order to help them avoid traffic and/or traffic related accidents. For example, embodiments of the present disclosure can further provide information to drivers regarding scheduled non-emergency events such as, but not limited to, races, road maintenance, marathons, parades, fairs, and/or neighborhood events as well as unscheduled non-emergency events such as segments of traffic signal failure, water or sewer main breaks, flooded streets, downed wires, street repairs, construction, work by public utility companies, work by private contractors, etc. Although specific examples of scheduled and unscheduled non-emergency events have been provided, one of skill in the art will recognize that such examples are provided as illustrative uses of embodiments of the present disclosure and that other types of emergency and/or scheduled and unscheduled non-emergency events, not explicitly detailed in the present disclosure, are contemplated within the scope of this disclosure. Still, further embodiments contemplated within the present disclosure provide useful information to drivers in case of emergencies other than police, fire, or medical emergencies. For example, in such embodiments, the systems and methods disclosed herein detect an emergency event and display appropriate route information to the driver. For example, in the case of a disaster or storm, the disclosed systems and methods may display evacuation routes, snow routes, flooded routes, information regarding hazardous materials, etc.

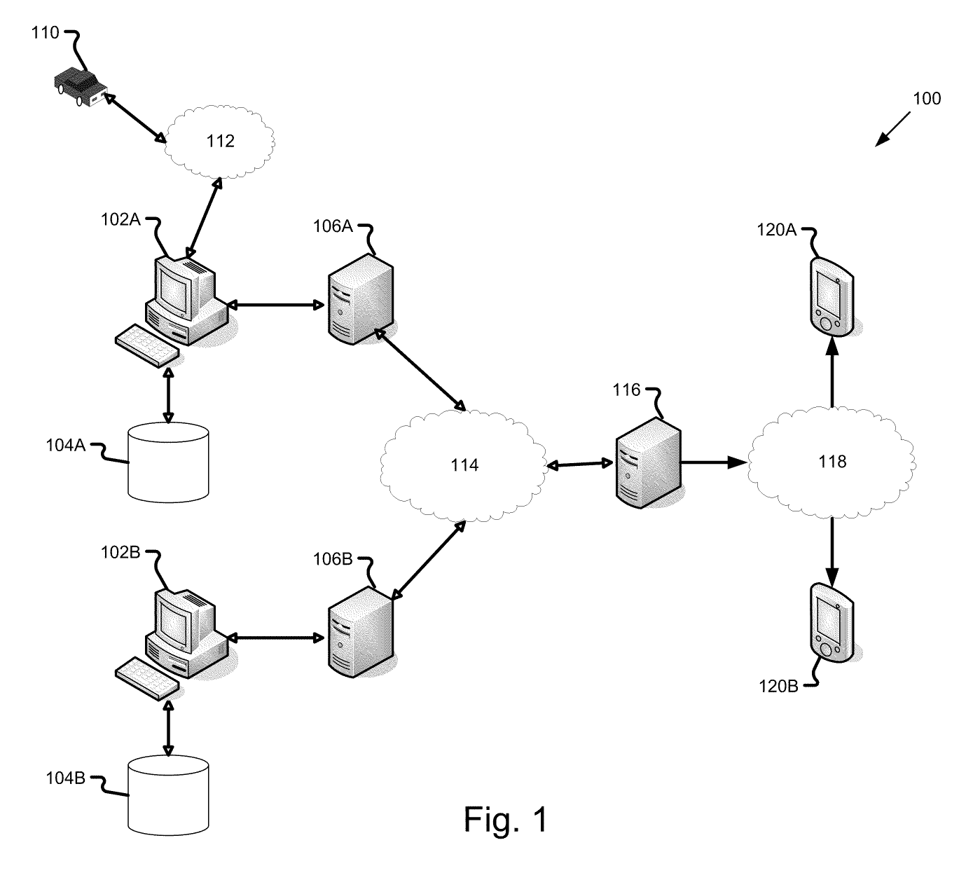

Embodiments of the present disclosure will now be illustrated with respect to the disclosed figures. FIG. 1 is an illustration of an embodiment of a system 100 for providing event notification. In embodiments, system 100 is operable to identify potential traffic interruptions due to emergencies situations, such as a police emergency, a fire emergency, a hazardous material emergency, severe weather, natural disasters, etc. In further embodiments, system 100 is operable to identify potential traffic interruptions due to non-emergency situations (whether scheduled or not) such as marathons, races, parades, neighborhood events, traffic light outages, water or sewer main brakes, flooded streets, downed wires, construction performed by public utilities and/or private contractors, etc. In still further embodiments, system 100 is additionally operable to identify the severity of the traffic interruption by determining the severity of the event by, for example, associating the event with a severity level. System 100 is further operable to transmit information related to such events to drivers thereby informing the drivers of the events and directing the drivers away from them.

System 100 may include an event recording client 102 that records events on an event datastore 104 communicatively connected to the event recording client 102. Although event datastore 104 is illustrated as separate from event recording client 102, one of skill in the art will appreciate that, in alternate embodiments, event datastore 104 may reside on the same machine as event recording client 102 (e.g., the event data store may be the hard drive associated with event recording client 102). In an embodiment, event recording client 102, such as event recording client 102A, may be a Computer Aided Dispatch (“CAD”) client used by, for example, a police dispatcher, a fire dispatcher, a 911 dispatcher, etc. CAD systems are known in the art and any suitable system or system with similar capabilities may be used. A user of event recording client 102A receives an emergency call and logs an event corresponding to the emergency which is stored in event datastore 104A. In embodiments, the event may be identified by a unique client event ID when storing the event occurrence in the event datastore 104.

Other event information may be associated with the event and stored in the event datastore 104. For example, other event information may include, but is not limited to, a type of event, a description of the event, a location of the event (e.g., the latitude and longitude coordinates of the event), a severity level, or any other type of information related to the event. Furthermore, any of the event information may be updated and stored in the event datastore 104 during the course of the event thus providing a dynamic event recording system. As an example, event recording client 102A may be a CAD client recording used by a 911 dispatcher to record a police related event such as a traffic accident, a burglary, a shooting, a riot, etc. A severity level may be associated with the police event (e.g., a level rated from 1-10, with 10 being the most severe) that may depend upon the type of police event being recorded. In one embodiment, the severity level of the event may be predetermined according to the type of police event. In another embodiment, the dispatcher recording the event may manually set the severity level based upon the specific details of the event. In alternate embodiments, a different scale may be used for the severity level. For example, a dispatcher recording an event related to a fire may have only two levels (e.g., emergency or non-emergency). Although the present disclosure provides specific examples of event types and severity levels, one of skill in the art will appreciate that any number of different event types and/or severity levels may be used. For example, federal, state and/or local agencies (e.g., a fire department, a parks and recreation department, a water district, a public works division, etc.) may maintain their own recording client 102 and the database 104 in order to record their own unique events having their own unique event data. Alternatively, a standardized system may be shared by multiple agencies.

In embodiments, the user (e.g., a dispatcher) entering event information at event recording client 102 may assign one or more assets 110 to the event. For example, referring again to the police event previously described, a dispatcher recording the event may assign one or more assets 110 to respond the police emergency. The one or more assets 110 may be emergency vehicles such as police cars, fire trucks, ambulances, hazardous material units, etc. In further embodiments, the assets need not be vehicles but may be individual emergency responders (e.g., police officers, firefighters, etc.). In order to track the assets assigned to an event, the assets may be identified by a unique asset ID and associated with the event ID corresponding to the event the asset is assigned to. In such embodiments, information regarding the assets assigned to the event is also stored in an event datastore 104, such as event datastore 104A.

In further embodiments, assets 110 may be equipped with an Automatic Vehicle Locator (“AVL”) or some other location component that provides the real-time location of the asset. The AVL allows the event recording client 102 and/or event datastore 104 to monitor an assets location thereby helping a dispatcher decide which asset(s) should be assigned to the event. In further embodiments, the assets vehicles may also have an AVL computer installed next to the driver (in the case where the asset is a vehicle) or carried as a personal device (in the case where the asset is an individual). The computer has the capability of receiving “notes” from the dispatcher and updates related to their emergency. Additionally, they can also monitor the position of other emergency vehicles within their agency (fire, police or ambulance) in the area regardless whether they are responding to emergency calls or not. In further embodiments, the location component may track additional data related to the asset and transmit the additional data to an event notification system 102 and/or event datastore 104. Other asset information may include, but is not limited to, whether an emergencies vehicle's warning lights are on or off, whether a siren is on or off, wheel rotation, the asset's status, etc.

The asset 110 may transmit its location information (using a location component, such as the AVL) to an event recording client 102 and/or event datastores 104 via a network 112. In embodiments, network 112 may be any type of network capable of transmitting data such as a wide area network (“WAN”), a local area network (“LAN”), the Internet, a cellular network, satellite network, or any other type of data network known in the art. In such embodiments where the asset 110 is equipped with a GPS component, the real-time location of the asset may be continually updated and stored with the asset information in the event datastore 104. However, in some situations it may not be desirable for an asset 110 to provide its real-time location. For example, a police vehicle responding to the scene of a crime may not want its location visible to others. Thus, alternate embodiments are provided where the asset can indicate that its location should not be transmitted. In such embodiments, the real-time location of the asset may or may not be provided to event datastore 104, however the location of the asset will not ultimately be displayed on the personal navigation device 120 (discussed in more detail below). While embodiments of the present disclosure describe the event datastore 104 as storing both client event and asset information, one of skill in the art will recognize that a separate datastore may be utilized in storing different types of event information without departing from the scope of the systems and methods disclosed herein.

Event notification system 100 also includes one or more event notification components 106. In embodiments, event notification components 106 are communicatively coupled to event recording clients 102 and/or event datastores 104. In one embodiment, event notification components 106 may be co-located with and directly connected to event recording clients 102 and/or event datastore 104. In another embodiment, event notifications components 106 may be remote systems connected to event recording clients 102 and/or event datastores 104 via a network such as, but not limited to, the Internet. In still further embodiments, event notification components may be a software component installed on event recording clients 102 and/or event datastores 104.

In embodiments, event notification components 106 are operable to gather information related to an event from an event datastore, such as event datastore 104A. The collected client information may include, but is not limited to, event IDs, event types, event severity levels, event location, etc. Referring again to the example of a police event, event notification components 106 may gather the unique client event ID, event type, the date of the event, and location of the event, which may be identified by GPS Latitude/Longitude coordinates, an address, etc. In still other embodiments, event notification components 106 are further operable to gather asset information from event datastores 104. Asset information may include a client asset identifier, the observation date (e.g., the date when the asset data was generated), the speed that the asset is traveling, the heading of the asset (for example, the heading may be identified by the cardinal direction the asset is travelling or reported in degrees, e.g., 0-369 degrees where 0 degrees is North), the asset's destination (which may be determined based on a client event ID associated with the asset, e.g., the event to which the asset has been assigned by the dispatcher) and the location of the asset (as identified by GPS latitude and longitude coordinates or by some other equivalent method).

The event and/or asset information may be gathered and continually updated by the event notification component 106 using a push system, a pull system, by continuously polling event recording clients 102 and/or event datastores 104, by receiving an interrupt indicating that there new data from event recording clients 102 and/or event datastores 104, or by any other method of gathering information known to the art. In embodiments, the event component 106 is associated with a separate datastore (not shown) that it uses to store information related to active events.

An event notification component, such as event notification component 106A, may be operable to package and/or process relevant event and/or asset information and transmit the processed information to a navigation provider 116 via a network 114. For example, the event notification component 106A may standardize, translate or alter the format of the client information for use by downstream systems. This may include assigning a new unique ID for use by the notification system to each client event and asset, translating the client-provided security level into a format expected by downstream systems, generating a new severity level for use by the notification system based on the client-provided event information (e.g., client security level, number of assets assigned, event type, etc.), and converting client-provided location information into a form suitable for use by the downstream systems.

In embodiments, network 114 may be any type of network capable of transmitting data such as a wide area network (“WAN”), a local area network (“LAN”), the Internet, a cellular network, satellite network, or any other type of data network known to the art. In embodiments, navigation provider 116 may be any type of navigation service provider that provides navigation and/or traffic related information to application service providers such as, but not limited to, Bing Maps, Google Maps, MapQuest, Garmin, Magellan, and/or TomTom. Navigation provider 116 receives the event and/or asset information from the event notification component 106 and processes the information in order to prepare the information for delivery to an application service provider. For example, navigation provider 116 may translate the information into a data format compatible with a particular application or device. As previously discussed, event notification components 106 may receive event notification from many different systems that may use disparate severity levels. Because of this, navigation provider 116 may process the received event information taking into account other information, such as traffic flow information, current traffic patterns, other traffic incidents within the proximity of the event, rush hour data, etc. to adjust received severity level information into a severity level that is standardized by the navigation provider 116 such that it is compatible with the application services.

In further embodiments, navigation provider 116 may generate instructions and/or commands for the various navigation applications and/or devices. Such commands may include, but are not limited to, displaying the location of an event on a map, displaying a traffic flow on a map, displaying an emergency vehicle on a map, calculating alternate routes for a user, etc. One of skill in the art will appreciate that the information received by navigation provider 116 may be used to perform various navigation and/or traffic operations known to the art. In alternate embodiments, such processes may be performed by event notification component 106 and prior to transmitting information to the navigation provider 116. In yet another embodiment, the generation of instructions and commands may be performed by the individual application service providers (not shown in FIG. 1) who receive event information from the navigation provider 116 before sending the commands to the personal navigation devices 120.

Navigation provider 116 is further operable to package and transmit information received from the event notification components 106 to application service providers that present navigation information on individual personal navigation devices 120. In alternate embodiments, navigation provider 116 may include additional logic such that it only sends information and/or commands to specific personal navigation devices 120. For example, individual personal navigation devices 120 may be equipped with GPS functionality identifying the location of the personal navigation device 120. Navigation provider 116 may send information related to an event and/or asset information only to personal navigation devices 120 within a certain proximity to the event and/or asset. In other embodiments, a personal navigation device 120 may be programmed with a specific route. In such embodiments, navigation provider 116 may only transmit event and/or asset information to navigations components 120 whose routes intersect with the event and/or asset location. While the disclosure presents an embodiment in which the application service commands are generated by the navigation provider, in alternate embodiments, these commands may be generated by specific application service servers (not displayed in FIG. 1) prior to being transmitted to the personal navigation devices 120. Although only two personal navigation devices 120 are illustrated in FIG. 1, one of skill in the art will appreciate that navigation provider 116 may transmit the information and or commands, either directly or via one or more application service providers, to any number of personal navigation devices 120.

In embodiments, personal navigation devices 120 include, but are not limited to, computing devices such as GPS systems, computers, laptops, cell phones, smart phones, PDAs, or any other device capable of executing and displaying navigation applications. Personal navigation devices 120 may include a display for presenting a user interface that displays traffic and/or route information to a user. In further embodiments, the user interface may display additional information such as a severity level associated with the event, for example, by color coding the event location according to the severity level, the type of the event, for example, by displaying a specific icon associated with an event type, or any other event related information as graphic or textual information. Furthermore, in alternate embodiments, the user interface is operable to display route information or alternate route suggestions to help a user avoid an event. For example, a personal navigation device 120 may alert the user to the approach of an emergency vehicle asset en route to an event.

The personal navigation devices 120 may also provide additional information to a user informing the user of approaching emergency vehicles. For example, the user interface could provide a specific message alerting the user such as “Emergency Vehicle Approaching from the Rear”, or “Emergency Vehicle Approaching from the North/East/South/West”, etc. Furthermore, an icon representing the emergency vehicles may be displayed on the user interface of the personal navigation devices 120 alerting the user to the real-time location and direction of travel of the emergency vehicle. In other embodiments, the personal navigation devices may also provide instructions to the user notifying the user to pull over to allow the emergency vehicle to safely pass. In such embodiments, the personal navigation device 120 may take into account the type of the road the user is on in order to provide specific directions on how to allow the emergency vehicle to safely pass. For example, if the user is on a two way street or highway, the user may be directed by a message such as “Pull over to the right” to allow the emergency vehicle to pass. If the user is on a one way street or a divided highway pulling over to the right may not be the best option. In such instances, the user may simply receive a message to “Pull over” allowing the user to make the best decision as to which direction to pull off to the side.

The logic to determine which notifications to send the user (e.g., depending on the location or type of road the user is traveling on) may be implemented by hardware or software located at the personal navigation device 120, the navigation provider 116, or any other component. In other embodiments, the navigation provider 116 may send messages to the personal navigation device 120 which include information related to the type of the asset, the direction the asset is travelling, alert messages notifying the user of an approaching emergency vehicle, instructions on avoiding an emergency vehicle, navigational directions, the location of an incident, the type of an incident, or any other type of message providing information relevant to the various embodiments disclosed herein. The personal navigation device 120 may provide the information related in the messages from the navigation provider 116 to a user via a user interface.

In further embodiments, the user interface is capable of displaying the real-time location of assets based upon information received from event components 106 and navigation providers 116. The responding asset may be generically represented on the user interface or the type of asset may be identified by the user interface by displaying a specific icon related to the asset type (e.g., the personal navigation device may display different unique graphical identifies for police cars, fire trucks, ambulances, etc). In further embodiments, the user interface may provide more detailed information related to the asset 110 such as, but not limited to, the direction the asset is traveling, the route the asset is following, the lane the asset is traveling, etc. The information displayed by the user interface of the personal navigation device 120 provides users with the ability to avoid events and or assets (such as, emergency vehicles) thereby alleviating traffic and reducing accidents related to events.

Embodiments of FIG. 1 have been described with respect to relaying information related to an emergency event recorded by a dispatcher using a CAD client, such as a 911 dispatcher; however, other embodiments of the present disclosure are operable to transmit information related to traffic events that may arise from non-emergency situations. Notification components 106 may also be in communication with event recording clients 102 and event datastores 104 associated with other public and/or private agencies or entities that record information related to traffic events. For example, notification components 106 may be associated with event recording clients 102 and event datastores 104 associated with various public works scheduling entities, such as, but not limited to public and/or private traffic engineering entities, wastewater entities, construction entities, and water entities. Event recording clients 102 and event datastores 104 associated with such entities may store additional information that relate to non-emergency events that have an effect on traffic situations such as information related to parade routes, race and/or marathon routes, traffic light outages, road construction, waterline breaks, evacuation routes, snow routes, etc. Event notification components 106 associated with such entities may gather and package event information from the public and private entities and transmit the information to navigation provider 116. Navigation provider processes the non-emergency event information and transmits the information and commands to personal navigation devices 120 for display to a user as previously described.

In yet another embodiment, the event notification component 106 may be employed with an event datastore 104 associated with a railroad operator. In such embodiments, the components described herein with respect to FIG. 1 may be used to provide information to a user detailing when a train (or other railroad asset that may have an impact on traffic) is approaching a train crossing. In such embodiments, the location of the train or other asset may be tracked by equipping it with a location component such as an AVL. In some embodiments trains may be equipped with two location components, one at the front of the train and one at the rear of the train. Equipping a train with two location components allows the disclosed systems to determine the span of the train which allows for a determination of what intersections are blocked by the train. Additionally, in the instance of a train accident, emergency responders will be able to quickly tell what intersections are blocked by the non-moving train which will allow the emergency responders to quickly coordinate their positioning around the accident. In other embodiments, the length of the train may be known to the disclosed components. In such situations, the span of the train may be calculated without the need for a second location component at the rear of the train. Furthermore, the embodiments disclosed herein may further be operable to recalculate a route for a user which allows the user to avoid waiting at a train signal crossing by avoiding the train's path.

While the embodiments described with respect to FIG. 1 have been illustrated such that individual event components 106A and 106B are associated with individual event recording clients 102 and datastores 104, one of skill in the art will appreciate that system 100 may also be organized as a hub-and-spoke system, in which a single event component 106 is communicatively coupled to multiple event recording clients 102 and event datastores 104. Additionally, one of skill in the art will further appreciate that the system described with respect to FIG. 1 is further extendable to incorporate any number of event recording clients 102, event datastores 104, and event components 106.

As displayed in the event notification system 100, a navigation provider may receive various different events from disparate sources. In some cases, two different sources may each provide separate event information identifying what is actually a single event as two distinct events. For example, a police dispatcher may indicate an event corresponding to a car accident that police units are responding to while an emergency medical service (“EMS”) dispatcher may identify the same accident as a separate event by entering the accident into the EMS system and dispatching an ambulance to the scene. In one embodiment, the system 100 may simply present the two events to the application service providers and/or personal navigation devices 120 independently as separate events without any attempt to correlate the two events based on location. Both events would then show up on the personal navigation device 120, thereby giving the user additional information of the seriousness of the event at that location. In another embodiment, either the navigation provider or the event notification components may perform a conflict resolution based on the temporal and physical proximity of the events being reported by the two event recording clients 102. For example, the system may recognize that the two events have the same location and therefore determine that they are the same event. In that case, the system may choose to use a single notification system event ID for all event information regardless of source for this location. In this way multiple client event IDs from different event notification clients may be associated with a single unique system event ID generated by the event notification component 106 or, alternately, by the navigation provider 116. In yet another embodiment, the system 100 may disregard any duplicative events reported, in favor of reporting only one event for any given time and location. The choice of which event to report may be made by time (e.g., report the first event received), by severity, by priority (e.g., the events of one agency may have a higher priority than another), or by simple random selection.

In other alternate embodiments, the event notification system 100 may be implemented by incorporating the event notification component 106 into existing dispatch systems that perform the functions of the event recording client 102 and event datastore 104. Such implementations allow existing dispatch system to be retrofit to allow event data to be automatically transmitted in real-time to navigation applications without changing existing dispatch procedures. In other embodiments, the event notification component 106 may or may not be co-located with the dispatch system and may or may not independently store event data. For example, for security reasons, some police departments may allow real-time dissemination of limited data to navigation applications but may not want any data stored outside of their secured network. If the notification component is co-located, it could store data within, or utilize data stored within, the secured network. If the notification component 106 is remotely located, data could be handled transitorily such that only current event data is available at any time.

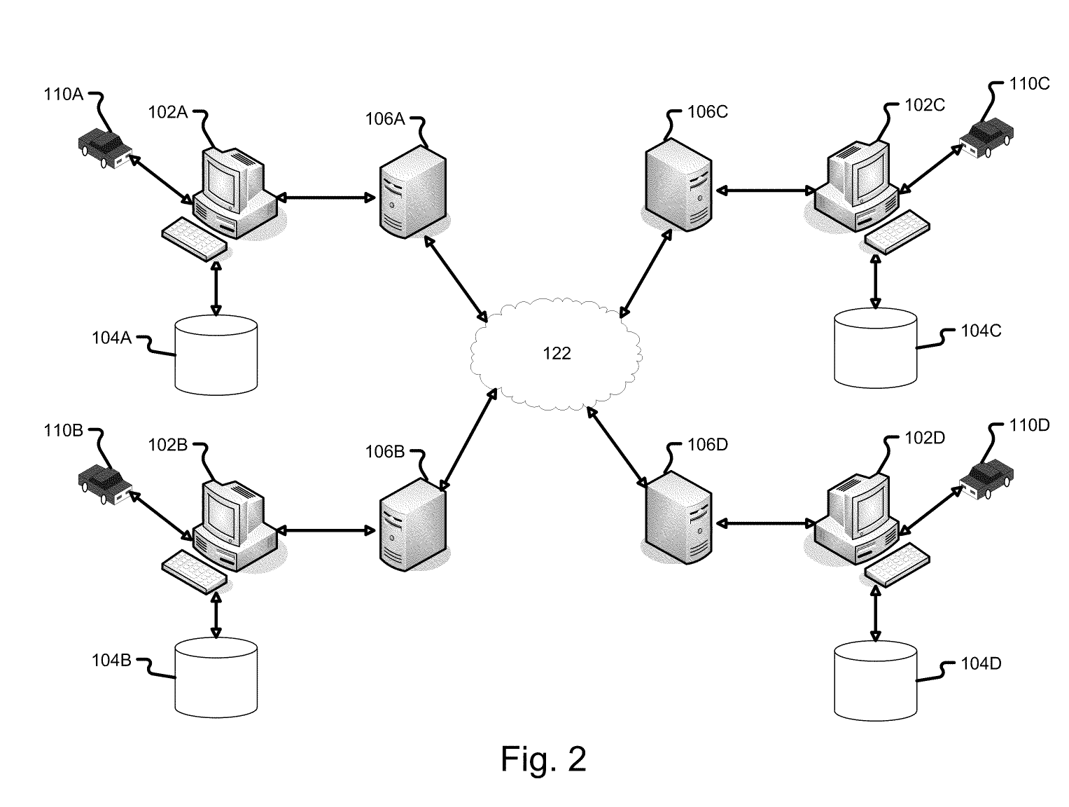

FIG. 2 is an illustration of an alternate embodiment of a system 200 operable to provide event notifications. As illustrated in FIG. 2, multiple event notification components (e.g., event notification components 106A-106D) may communicate across a network 122. Network 122 may be any type of network capable of transmitting data such as a wide area network (“WAN”), a local area network (“LAN”), the Internet, a cellular network, satellite network, or any other type of data network known to the art. Each event notification component may communicate with assets (e.g., assets 110A-110C) associated with the event notification components. As shown in FIG. 2, event data may be transmitted across a closed system between event notification components 106 and dispatch systems 102 of different departments/agencies. For example, event notification components located at a 911 dispatch, a police dispatch, a fire dispatch, and/or an EMS dispatch may communicate with one another and exchange information related to the events recorded at the different dispatch locations. In the closed embodiments, more detailed information may be transmitted between the different locations because, unlike the embodiments where some event information is or could potentially be made public, it may be more desirable for different agencies to share more information. For example, the additional information may include an asset ID, a unit ID, a rig ID, the identity of the responding units, information about the personnel and emergency responders at the scene, information related to the agencies at or responding to the incident, the identity and/or location of the incident commander, the location of the incident command post, or any other information relevant to the incident, the personnel, and/or the emergency responders. Such information may be available by passing the information between the event notification components (e.g., event notification components 106A-106B). In other embodiments, all the information may be centralized by a National Incident Management System (“NIMS”) that may be connected to the system illustrated in FIG. 2 (not shown) and distributed among the various agencies via the embodiments disclosed with respect to FIG. 2. The closed embodiments disclosed provide for increased cooperation and efficiency among the different agencies responding to the scene. Such embodiments are particularly beneficial with respect to Homeland Security incidents when many different agencies are responding to the same incident by providing a way for the agencies to communicate their positioning and information among each other. The closed system of FIG. 2 further provides a dynamic system for continually updating information between agencies responding to an incident as information changes.

Similarly, other public and private agencies may participate in the closed notification system illustrated in FIG. 2. While FIG. 2 describes an embodiment with multiple event notification components 106, one of skill in the art will appreciate that alternate embodiments of FIG. 2 may be practiced in which the system is organized in a hub-and-spoke manner using a single event notification component 106.

The embodiments illustrated in FIGS. 1 and 2 are examples of two different tiers of services that may be provided by the systems and methods disclosed herein. As described in FIG. 1, an event notification system can be extended to the public by publishing event notification to personal navigation devices 120. At the same time, the different event notification components 106 can communicate amongst each other to exchange more detailed information between the various agencies or entities employing the event notification systems and methods disclosed herein.

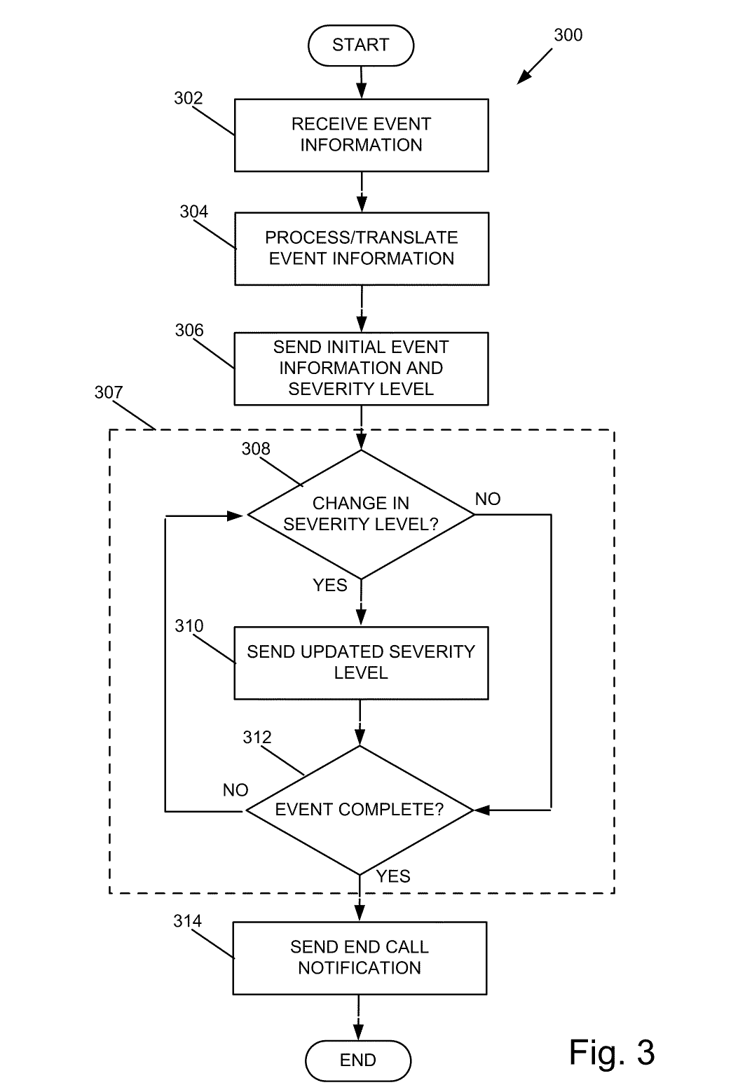

Referring now to FIG. 3, FIG. 3 illustrates a flow chart representing an embodiment of a method 300 for providing emergency event information. Flow begins at operation 302 where the emergency event information is received. In embodiments, an event component, such as event component 106 (FIG. 1) receives event information from an event datastore, such as event datastore 104 (FIG. 1). In one embodiment, the event component receives event information including an event ID, a location of the event, and a severity level associated with the event. In such embodiments, the location of the event may be the latitude and longitude coordinates of the event. In another embodiment, the location of the event may be an address or an intersection. In alternate embodiments, an event component may receive additional event information other than an event ID, location, and severity level at operation 302.

Assets (e.g., police units, fire trucks, ambulances, etc.) are assigned to handle emergency events. Thus, in further embodiments, the event component also receives information related to the assets assigned to the event at operation 302. In embodiments, assets are assigned to an event by being correlated with the event ID. Thus, the event component may receive asset information for each asset associated with the event ID received in operation 302. In embodiments, asset information received by the event component may include, but is not limited to, an asset ID, an asset type, the real-time location data of the asset (identified by its latitude/longitude coordinates), the speed at which the asset is traveling, and/or the heading the asset is traveling. Assets may be treated and reported as an event in and of themselves independent of any location-specific event (that is as an event that is moving over time) or, alternatively, may be associated with a location-specific event and reported as an associated asset so that the application provider and/or end user is able to distinguish between moving assets and events. The asset information may be transmitted by a location device located on the asset. In one embodiment, the location device may be capable of transmitting asset information (e.g., location, speed, direction of travel, etc) as well as receiving information from the disclosed systems and methods (i.e., location of other assets, location of incident, etc). In another embodiment, a separate device may be used to receive information from the disclosed systems and methods.

Flow proceeds to operation 304 where the severity level and other client-generated information are processed for use by downstream components. For example, in embodiments the system may change the severity level received at operation 302 to a severity level compatible with the event notification component, the navigation provider, such as navigation provider 116 (FIG. 1), or other downstream system. As described with respect to FIG. 1, the embodiments disclosed herein are capable of receiving event information from various types of event sources having their own systems and event recording clients (e.g., a CAD client, a public works agency, etc). Each event recording client may assign different severity levels to the events they record. Therefore, to ensure uniformity, the severity level may be standardized such that it is compatible with the event notification component, a navigation provider, or application service provider. In one embodiment, a new severity level is calculated as a function of the number of assets assigned to the event, the type of the event, the level of severity received, and the number of assets at the scene of the event. In further embodiments, additional information such as the location of the event, current traffic flow data, or any other information available to the components disclosed herein may be used in localizing severity. For example, if the event is in a location that normally receives a high amount of traffic, the localized severity level may be increased. Conversely, if the event is in a low traffic area, the localized severity level may be decreased. One of skill in the art will appreciate that methods and information other than the examples provided with respect to operation 304 may be employed for severity localization.

In embodiments, operation 304 also includes performing a general translation operation on the information received (e.g., the event ID, the asset ID, the location, etc.) at operation 302. For example, the translation operation may include generating a second event ID that is unique to the event component and/or the navigation provider. It may be necessary to translate the event asset ID to ensure that the ID's are in a form that is compatible with the notification component and the navigation component. As discussed, the event notification component and the navigation component are capable of receiving event information from a variety of event recording clients and datastores. Each event recording client may have its own unique way of identifying event ID's, asset ID's, and location. Thus, it may be necessary to translate the received information into a form that is compatible with the notification component and or navigation provider's operation. Furthermore, generating new event and asset IDs at operation 304 provides the benefit of ensuring that all the disparate information received by the notification component is uniquely identified despite the fact that the information may be received from a variety of different sources. An additional benefit is provided by translating the asset IDs at operation 304. Translation of the asset IDs helps to maintain the anonymity of the assets assigned to the event. This may be required, for example, by a police department participating in the event notification system disclosed herein.

Furthermore, it should be noted that multiple information processing operations (not shown) may be performed, such as by different components of the overall system. For example, the event notification component 106 may generate a new standardized severity level for each event based on information, including the client-assigned severity, from the dispatch system. This severity level may then be further adjusted (localized) by the navigation provider based on local traffic flow information which is available to the navigation provider but not available to the event notification component. This allows the system, for example, to report what would otherwise be identical emergencies (in terms of event type, number of assets assigned, etc.) as having different severities based on the location of the event (e.g., when one event occurs at a very busy freeway while the other event occurs on an infrequently traveled agricultural road.

After the information has been processed, flow proceeds to operation 306 where the event component sends the processed event information to a notification provider. The information sent at operation 306 will be used to generate information to be displayed to the user via a personal navigation device, such as personal navigation device 120 (FIG. 1). In embodiments, operation 306 further entails continuously sending real-time location information for all assets assigned to the event.

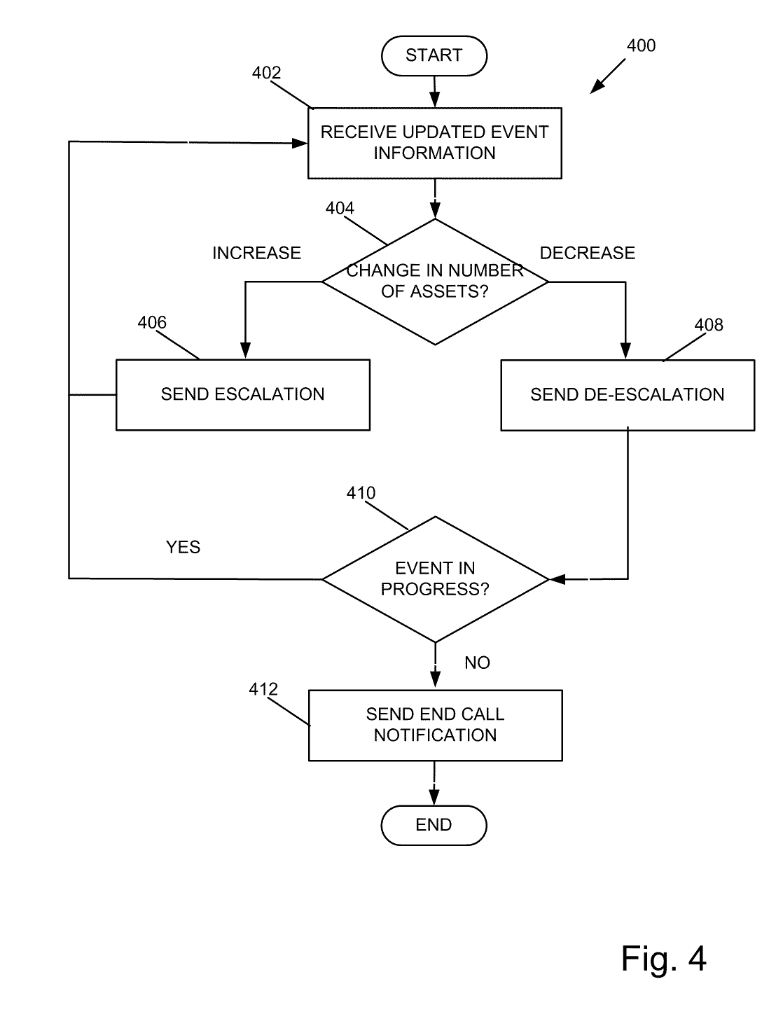

After the initial event has been reported, the system then enters a monitor and update mode illustrated by the dashed box 307 which monitors for changes in the event in order to revise the severity level as conditions change. In the monitoring and updating operation 307, flow proceeds to operation 308 where the event component determines if there is a change in the severity level based on new information about the event as it is obtained. The determination of a change in severity level will be further described with respect to FIG. 4. If there is a change in the severity level, flow branches YES to operation 310. At operation 310, updated severity information is sent to the notification provider and flow proceeds to operation 312. Referring back to operation 308, if there is no change in the severity level, flow branches NO to operation 312.

At operation 312, the event component determines if the event has ended. In one embodiment, the event component determines that the event has ended when it receives notification that the event has terminated from the event datastore. Additional embodiments of a method for determining if the event has ended are described with respect to FIG. 4. If the event has ended, flow branches YES to operation 314. At operation 314, an end call notification is sent to the notification provider indicating that the event has terminated and that it can be removed from navigation applications. If the event has not ended, flow branches NO to operation 308 and flow continues until the event has ended.

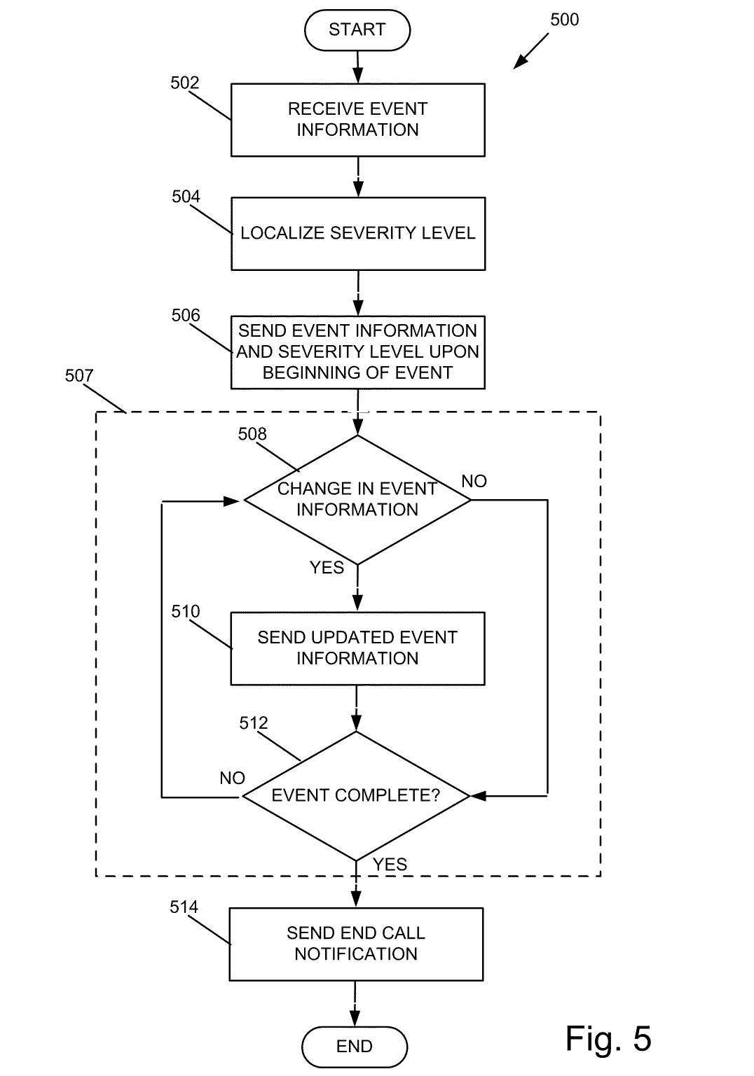

The reader will understand that the method described in FIG. 3 is a real-time method in which data describing current conditions are streamed to the navigation applications. The event component that streams the current condition may be simply passing on some or all of the information obtained from an event recording client or database. In other situations, such as scheduled events like as races, the event notification component may be generating current information based on the data describing the schedule (e.g., based on data stating a road will be closed from 10 until 4, at 10 the event notification component may begin generating real-time information indicating that the road is closed). Further detail on providing information for scheduled events is discussed with respect to FIG. 5.

FIG. 4 is a flow chart illustrating an embodiment of a method 400 for determining whether there is a change in the severity level during an active emergency event. Flow begins at operation 402 where an event component, such as event component 106 (FIG. 1) receives updated event information from an event datastore, such as event datastore 104 (FIG. 1). Flow proceeds to operation 404 where the event notification component determines if there has been a change in the number of assets assigned to the event. This may occur when a dispatch assigns a new asset to an existing event or de-assigns an asset to an event. In an embodiment that correlates events from different dispatch systems, calculation of the number of assets may also include aggregating the number of assets assigned from different agencies or departments.

If the number of assets assigned to the event increases there is an escalation in the event. For example, the number of assets may increase if an event dispatcher (e.g., a 911 dispatcher) assigns more assets to the event which would result in an escalation of severity. If the number of assets has increased, flow then branches INCREASE to operation 406 and the event notification component sends an event escalation indication. The event escalation indication increases the localized severity level associated with the event. In other embodiments, an event escalation indication may not be sent until the increase in the number of assets reaches a specific threshold, predetermined range, or ordered by the incident commander. For example, escalation indications may not be sent until enough assets have been assigned so as to increase the severity level of the event. In alternate embodiments, the localized severity level of the event may not increase until a predetermined number of event escalation indications are sent by the event notification components. Flow then returns to operation 402.

Referring back to operation 404, if the number of assets decreases, flow branches DECREASE to operation 408. For example, the number of assets may decrease if a dispatcher removes assets from an event or if an asset completes its assignment with regard to the event. At operation 408, the event notification component sends an event de-escalation indication. In embodiments, the event de-escalation indication decreases the localized severity level associated with the event. Alternatively, an event de-escalation indication may not be sent until the decrease in the number of assets reaches a specific threshold or brings the event to a lower severity level. In other embodiments, the localized severity level of the event may not decrease until a predetermined number of event de-escalation indications are sent by the event notification component.

Flow proceeds from operation 408 to operation 410 where a determination is made as to whether the event is still in progress. In an embodiment, the event notification component determines if there are any remaining assets assigned to the event after each change in number of assets. If there are remaining assets, the event is still in progress and flow branches YES and returns to operation 402. If there are no additional assets assigned to the event, then the event may be deemed completed, and flow branches NO to operation 412. In operation 412, an end call notification is sent to the notification provider indicating that the event has terminated and can be removed from navigation applications. In another embodiment, the determination of whether an event is still in progress is based upon a progress indication received from an event recording client or an event datastore. In such embodiments, the recording client or the datastore may periodically send an indication that an event remains in progress. The recording client or datastore may also send and end event indication. If an end event indication is received, operation branches NO to operation 412.

Regardless of the method used, if the system determines that the event is still in progress flow branches YES and returns to operation 402 in which it monitors for new information While the embodiments described with respect to FIG. 4 define severity level escalation and de-escalation with respect to the number of assets present at the incident and/or responding to the incident, escalation, de-escalation, and termination of the event may be accomplished by receiving other types of information. For example, an incident commander may send specific messages to the system which cause instruct the system to escalate the severity level, de-escalate the severity level, or even terminate the incident. One of skill in the art will recognize that other methods of escalation, de-escalation, and termination of events may be practiced with the systems and methods disclosed herein.

FIG. 5 is a flow chart representing an embodiment of a method 500 for providing non-emergency (e.g., previously scheduled) event information. Flow begins at operation 502 where the event notification component, such as event notification component 106 (FIG. 1) receives information about a non-emergency event from an event datastore, such as event datastore 104 (FIG. 1). In an embodiment, the non-emergency event information may be received from an event datastore associated with a public works datastore, as described with respect to FIG. 1. Alternatively, information may be directly entered into the event notification component by personnel associated with or regulating the event. Non-emergency event information may include additional information not present in other event datastores. For example, non-emergency events may be related to scheduled events such as races, parades, and/or scheduled construction. Such events include information such as a start time and an end time for the event. Additionally, non-emergency events may not be confined to a particular area but a route, as is the case with a parade or a race. For example, specific streets to blocked off and the period during which they are scheduled to blocked off may be included. Thus, the event location information may include an entire route rather than just latitude and longitude coordinates, an address, or an intersection.

After receiving the event information, flow proceeds to operation 504 where the event severity level is processed. In embodiments, the processing at operation 504 may be similar to the processing operations described with respect to FIGS. 3 and 4. In other embodiments, the severity level may be calculated according to characteristics of the non-emergency event, such as but not limited to, a full closure of the road, partial closure of the road, no road closure, etc. In further embodiments, operation 504 may include a translation operation (similar to the translation operation described with respect to operation 304) in order to translate event information received at operation 502 into a form that is compatible with the navigation component and/or navigation provider.

Flow proceeds to operation 504 where the event notification component sends the processed event information to the notification component upon the start of an event. For example, in one embodiment where the event has a determined start time, such as a parade or race, the event notification component sends the event information upon reaching the specific start time.

Flow then proceeds to a monitoring and updating operation 507. The monitoring and updating operation 507 begins with operation 508 where the event notification component determines if there is a change in the event information, that is, based on the current time has there been a change in conditions relative to the last event information transmitted to the navigation application. Alternatively, this may occur in response to the event notification component receiving an update to event information. In yet another embodiment, the non-emergency event may be combined with any associated “emergency” events such as dispatched assets or events in other event datastores and changes in those events may be associated with the non-emergency event. There are many different options available for determining if a change has occurred based on the information available to the different components of the system, and any method or criteria that meet the needs of the operator may be used herein.

If the event notification component determines that there is not an update to event information, flow branches NO to operation 512. However, if there is a change in event information, flow branches YES to operation 510 and the event notification component sends the updated event information to the notification component. For example, if the current time indicates, based on the scheduled event information, that a parade should now be approaching or leaving a particular intersection (or that a road should be closed in anticipation of the parades progress), data will be transmitted to the navigation application so that the navigation application is aware of the presumed current conditions and those conditions can be transmitted to the personal navigation devices. In one embodiment, this information may be tracked by having a detailed schedule of the parade stored and available to the event notification component. In another embodiment, vehicles participating in or assigned to the parade may be equipped with a device like the AVL that transmits the real-time location of the vehicle. For example, if the last vehicle in the parade is equipped with an AVL, the event notification component can track the tail end of the parade and determine which areas of the parade route are completed and thus open to traffic. After sending the updated notification flow then proceeds to operation 512.

At operation 512, the event notification component determines if the event has concluded. For example, in the case of parade or race, the event component determines if the end time of the event has been reached. In another embodiment, assets may be assigned to the non-emergency event. In such an embodiment, the determination at 512 may be similar to the determination of the termination of the event as described in FIGS. 3 and 4. In yet another embodiment, the event notification component may receive an indication that the event has terminated from the event data store. If the event has not ended, flow returns to operation 508 and the event coordinator again checks for a change in event information. If the event has ended, flow branches YES to operation 514 and the event notification component sends and end call notification to the personal navigation device signaling the end of the event.

While the embodiments of the methods described in FIGS. 3-5 have been described as being performed by an event notification component, one of skill in the art will appreciate that the components of the systems described in FIGS. 1-2 may be combined without departing from the scope of the present disclosure. Thus, in alternate embodiments, the methods described in FIGS. 3-5 may be performed by other components disclosed herein, such as but not limited to, the navigation provider. In other embodiments, the methods disclosed herein may be practiced by software installed on general computing devices.

Furthermore, the methods presented in FIGS. 3-5 should be considered specific embodiments of general methods for delivering real time event information to a personal navigation device. As such, the disclosed embodiments should not be considered limiting the scope of this disclosure or the system as a whole. The reader will understand that numerous alternative embodiments are possible in which the various operations described may be reordered or performed in parallel to achieve the same result. For example, in an alternative embodiment of FIG. 5 the send updated event information operation 510 may not be performed until after the event complete determination operation 512 has been finished.

In the embodiments described above, the information received from the datastore and/or transmitted to the navigation applications could be intentionally limited or modified in order to prevent the unwanted disclosure of sensitive information. For example, in some cases, such as for instance shootings or arrests, it may not be desirable that the nature of the event be displayed to end users. The embodiments described herein could be adapted so that only a notification that a severe event affecting traffic is occurring at that location. Similarly, in cases in which there is a desire that the location of an asset assigned to an event be kept secret, the asset may be given a specific type code preventing it from being displayed to end users in a way that would allow it to be identified. For example, in such a situation the location of the asset may not be transmitted to the navigation application or may be assigned a generic traffic disruption type identifier. Other ways of providing limited information are also possible. In still further embodiments, the systems and methods disclosed herein may be modified such that no emergency vehicles or events are disclosed to the public. An indicator or flag may be set to stop transmitting emergency information. In such embodiments, the indicator or flag may be changed, thus allowing the systems and methods to toggle between displaying or not displaying emergency information.

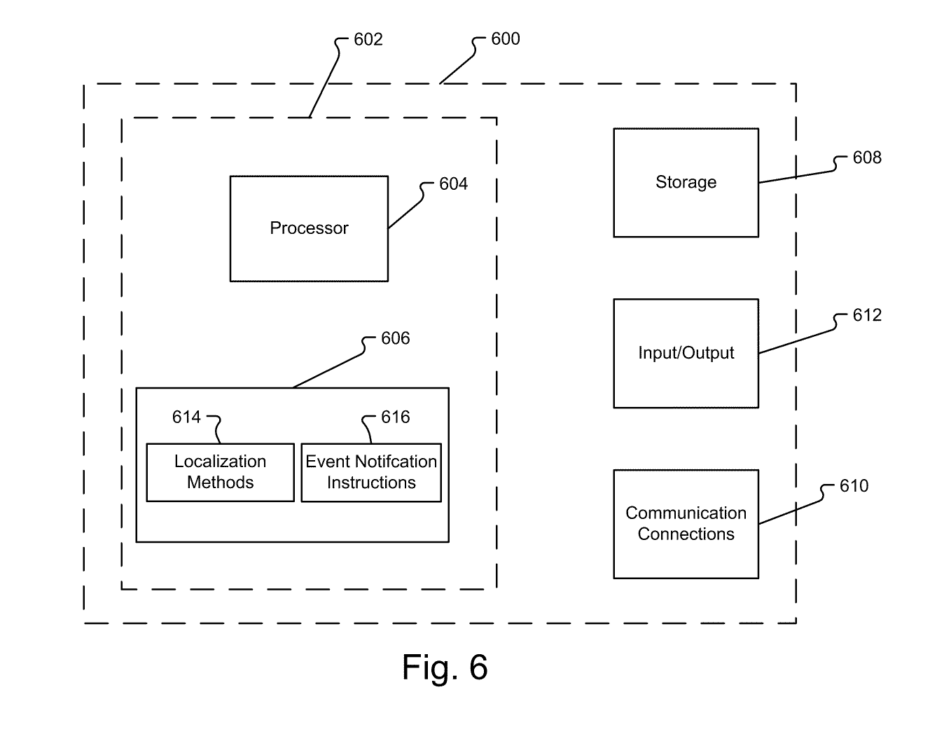

The disclosed systems and methods may be performed using logic implemented in hardware or in software executed by hardware. With reference to FIG. 6, an embodiment of a computing environment for implementing the various embodiments described herein includes a computer system, such as computer system 600. Any and all components of the described embodiments may execute as or on a client computer system, a server computer system, a combination of client and server computer systems, a handheld device, and other possible computing environments or systems described herein. As such, a basic computer system applicable to all these environments is described hereinafter.

In a very basic configuration, computer system 600 comprises at least one processing unit or processor 604 and system memory 606. The most basic configuration of the computer system 600 is illustrated in FIG. 6 by dashed line 602. In some embodiments, one or more components of the described system are loaded into system memory 606 and executed by the processing unit 604 from system memory 606. Depending on the exact configuration and type of computer system 600, system memory 606 may be volatile (such as RAM), non-volatile (such as ROM, flash memory, etc.), or some combination of the two.

Additionally, computer system 600 may also have additional features/functionality. For example, computer system 600 includes additional storage media 608, such as removable and/or non-removable storage, including, but not limited to, magnetic or optical disks or tape or any other type of non-transitory storage media. In some embodiments, software or executable code and any data used for the described system may be permanently stored in storage media 608. Storage media 608 includes volatile and non-volatile, removable and non-removable media implemented in any method or technology for storage of information such as computer readable instructions, data structures, program modules, or other data. In embodiments, the capability negotiation methods and wrapper inner methods are stored in storage media 608.

System memory 606 and storage media 608 are examples of computer storage media. Computer storage media includes, but is not limited to, RAM, ROM, EEPROM, flash memory or other memory technology, CD-ROM, digital versatile disks (“DVD”) or other optical storage, magnetic cassettes, magnetic tape, magnetic disk storage, other magnetic storage devices, or any other medium which is used to store the desired information and which is accessed by computer system 600 and processor 604. Any such computer storage media may be part of computer system 600. In some embodiments, mammogram images and/or results of probability determination are stored in system memory 606. In embodiments, system memory 606 and/or storage media 608 stores data used to perform the methods or form the system(s) disclosed herein, such as receiving and updating event information, localization of severity levels, etc. In embodiments, system memory 606 would store information such as severity localization methods 614 and event notification instructions 616 for performing the methods described herein. In embodiments, localization methods 614 may be used to perform severity localization by an event notification component or a navigation provider component. Event notification instructions 616, in embodiments, store the instructions necessary to perform the methods described with respect to FIGS. 2-4.

Computer system 600 may also contain communications connection(s) 610 that allow the device to communicate with other devices. In embodiments, communications connection(s) 610 may be used to transmit and receive messages between sender devices, intermediary devices, and recipient devices. Communication connection(s) 610 is an example of communication media. Communication media may embody a modulated data signal, such as a carrier wave or other transport mechanism and includes any information delivery media, which may embody computer readable instructions, data structures, program modules, or other data in a modulated data signal. The term “modulated data signal” means a signal that has one or more of its characteristics set or changed in such a manner as to encode information or a message in the data signal. By way of example, and not limitation, communication media includes wired media such as a wired network or direct-wired connection, and wireless media such as an acoustic, RF, infrared, and other wireless media. In an embodiment, webpages may be transmitted over the communication connection(s) 610.

In some embodiments, computer system 600 also includes input and output connections 612, and interfaces and peripheral devices, such as a graphical user interface. Input device(s) are also referred to as user interface selection devices and include, but are not limited to, a keyboard, a mouse, a pen, a voice input device, a touch input device, etc. Output device(s) are also referred to as displays and include, but are not limited to, cathode ray tube displays, plasma screen displays, liquid crystal screen displays, speakers, printers, etc. These devices, either individually or in combination, connected to input and output connections 612 are used to display the information as described herein. All these devices are well known in the art and need not be discussed at length here.

In some embodiments, the component described herein comprise such modules or instructions executable by computer system 600 that may be stored on computer storage medium and other tangible mediums and transmitted in communication media. Computer storage media includes volatile and non-volatile, removable and non-removable media implemented in any method or technology for storage of information such as computer readable instructions, data structures, program modules, or other data. Combinations of any of the above should also be included within the scope of readable media. In some embodiments, computer system 600 is part of a network that stores data in remote storage media for use by the computer system 600.

This disclosure described some embodiments of the present disclosure with reference to the accompanying drawings, in which only some of the possible embodiments were shown. Other aspects may, however, be embodied in many different forms and should not be construed as limited to the embodiments set forth herein. Rather, these embodiments were provided so that this disclosure was thorough and complete and fully conveyed the scope of the possible embodiments to those skilled in the art.

Although the embodiments have been described in language specific to structural features, methodological acts, and computer-readable media containing such acts, it is to be understood that the possible embodiments, as defined in the appended claims, are not necessarily limited to the specific structure, acts, or media described. One skilled in the art will recognize other embodiments or improvements that are within the scope and spirit of the present disclosure. For example, the systems and methods were described above in the context of pushing real-time data of new events and changes to events to navigation applications so that the navigation application need only display the most recently received data without much or any modification being necessary. In an alternative embodiment, instead of sending changes and thereby updating event information only when a change is detected, for each event the system could send current event information periodically, such as every 30 seconds, for each active event. Other ways of providing real-time information regarding current conditions are also known and could equally be used depending on the preference of the parties involved. Therefore, the specific structure, acts, or media are disclosed only as illustrative embodiments and should not be considered as limiting the scope of this disclosure.

What is claimed is:

1. A computer storage medium encoding computer executable instructions that, when executed on a processor, perform a method of providing event notification, the method comprising:
receiving, from an event store, a client event ID, wherein the client event ID is associated with an event;
receiving, from the event store, a client severity level associated with the event;
receiving, from the event store, a location of the event; and
sending, to a navigation provider, a second event ID associated with the client event ID, a second severity level determined based on the client severity level, and the location of the event.

2. The computer storage medium of claim 1, wherein the method of providing event notification further comprises:
receiving, from the event store, information related to at least one asset assigned to the event; and
sending, to the navigation provider, the information identifying to the at least one asset.

3. The computer storage medium of claim 2, wherein the information related to the at least one asset further comprises:
a real-time location of the at least one asset; and
a type of the at least one asset.

4. The computer storage medium of claim 3, wherein the method of providing event notification further comprises sending, to the navigation provider, updated real-time location of the at least one asset.

5. The computer storage medium of claim 2, wherein the method of providing event notification further comprises:
determining a new second severity level associated with the event based on information from the event store; and
sending, to the navigation provider, the new second severity level associated with the event.

6. The computer storage medium of claim 5, wherein determining the new severity level associated with the event comprises is a function based upon at least one of:
a number of assets assigned to the event;
a type of the event;
the level of severity received from the event store; and
a number of assets present at the location of the event.

7. The computer storage medium of claim 2, wherein the method of providing event notification further comprises:
determining an event escalation; and
sending the event escalation to the navigation provider.

8. The computer storage medium of claim 7, wherein the event escalation is determined by an increase in the number of assets assigned to the event.

9. The computer storage medium of claim 1, wherein the event location comprises latitude and longitude coordinates of the location.

10. The computer storage medium of claim 1, wherein the event location comprises route information.

11. The computer storage medium of claim 1, wherein the new severity level associated with the event is based upon one of:
an indication of a full road closure;
an indication of a partial road closure; and
an indication of no road closure.

12. The computer storage medium of claim 1, wherein the method of providing event notification further comprises sending, to the navigation provider, an end event notification upon termination of the event.

13. The computer storage medium of claim 1, further comprising receiving updated information from the event store.

14. A system for providing event notifications, the system comprising:
a first event notification component communicatively coupled to a first event datastore, the first event notification component performing steps comprising:
receiving first event information related to a first event from the first event datastore;
generating a severity level for the first event based on the first event information; and
sending information related to the first event to a navigation provider component, wherein the information sent includes an event ID, the severity level and a location.

15. The system of claim 14, further comprising:
the first event datastore and a second event datastore, each datastore storing information related to one or more events comprising, for each event:
an event ID;
a severity level associated with the event; and
a location.

16. The system of claim 15, wherein the second event datastore is communicatively coupled to the first event notification component, and wherein the first event notification component further performs steps comprising:
receiving second event information related to a second event from the second event datastore;
storing the second event information related to the second event; and
sending the information related to the second event to the navigation provider component.

17. The system of claim 16, further comprising a second event notification component communicatively coupled to the second event datastore, the second event notification component performing steps comprising:
receiving second event information related to the second event from the second event datastore;
storing the second event information related to the second event; and
sending the information related to the second event to the navigation provider component.

18. The system of claim 14, wherein the sent information related to the first event further comprises:
a real-time location of at least one asset associated with the first event.

19. The system of claim 18, wherein the sent information related to the first event further comprises:
an asset type associated with each asset.

20. A system of providing event notification, the system comprising:
a first event datastore, the first event datastore storing first event information related to a first event, wherein the first event information includes:
an event ID;
a severity level associated with the first event;
a location for the first event; and
information related at least one asset assigned to the first event;
a first event notification component communicatively coupled to the first event datastore, the first event notification component performing steps including:
receiving first event information related to a first event from the first event datastore;
generating first navigation alert information based on the first event information; and
sending the first navigation alert information to a navigation provider component;
a second event datastore, the second event datastore storing second event information related to a second event, wherein the second event information includes:
an event ID;
a severity level associated with the second event; and
a location for the second event;
a second event notification component communicatively coupled to the second event datastore, the second event notification component performing steps including:
receiving second event information related to the second event from the second event datastore;
generating second navigation alert information based on the second event information related to the second event; and
sending the second navigation alert information to the navigation provider component;
the navigation provider component communicatively coupled to the first and second event notification components, wherein the navigation provider component performing steps comprising:
receiving the first navigation alert information;
determining a new severity level of the first event;
receiving the second navigation alert information;
determining a new severity level of the second event; and
sending, the first navigation alert information, the second navigation alert information, and the new severity levels associated with the first and second events to a personal navigation device; and
the personal navigation device communicatively coupled to the navigation provider component, the personal navigation device performing steps comprising:
receiving the information related to the first event, the new first severity level, the information related to the second event, and the new second severity level to a personal navigation device; and
providing a graphical user interface displaying an indication of at least one of the first and second events to the user.
